(19) United States
(12) Patent Application Publication
(10) Pub. No.: US 2006/0277556 A1
(43) Pub. Date: Dec. 7, 2006

(54) Tray of optical drive

(75) Inventor: Li Li, Jiangsu (CN)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/445,159

(22) Filed: Jun. 2, 2006

(30) Foreign Application Priority Data
Jun. 6, 2005 (TW) 94118569

(51) Int. Cl. G11B 17/04

(52) U.S. Cl. 720/613

(57) ABSTRACT

A tray for an optical drive. The tray comprises a main body, a first depression formed on the main body for a first disc, a second depression formed on the first depression for a second disc smaller than the first disc, and at least one first latching module disposed on the edge of the second depression. When the tray is vertically disposed, the second disc is positioned in the second depression by the first latching module.

### BACKGROUND

The invention relates to a tray of an optical drive, and in particular to a tray capable of holding an optical media disc when the tray is vertically disposed.

Optical media discs are typically available in diameters of 12 cm and 8 cm respectively. Two depressions are formed in the tray of an optical drive to accommodate both disc types as shown in FIG. 1. A tray 10 comprises a main body 12. A first depression 14 is formed on the main body 12 for 12 cm discs. A second depression 16 is formed on the first depression 14 for 8 cm discs in diameter. FIG. 2 shows that the height of the first depression 14 and the second depression 16 are different respectively to accommodate discs of different size.

To reduce the space occupied by the computer, certain optical drives are vertically disposed in the computer housing or disposed in an external box which is vertically disposed on a substrate. In such a condition, a latch 18 is disposed at the edge of the first depression 14 for disc positioning. In the conventional design, however, the latch 18 is employed for 12 cm discs rather than 8 cm disc. When the tray 10 is vertically disposed, the 8 cm discs cannot be used due to positioning.

### SUMMARY

An exemplary embodiment of a tray of an optical drive comprises: a main body; a first depression formed on the main body for a first disc; a second depression formed on the first depression for a second disc smaller than the first disc; and at least one first latching module disposed at the edge of the second depression. When the tray is vertically disposed, the second disc is positioned in the second depression by the first latching module.

The first latching module comprises a bracket extending parallel to the first depression, and a latch pivoted on the bracket and can be positioned parallel or perpendicular to the bracket. When the latch is parallel to the bracket, the first disc can be received in the first depression. When the latch is perpendicular to the bracket, the second disc can be received in the second depression and positioned therein.

The bracket can comprise a bore, and the latch can comprise a shaft rotatably engaging the bore, whereby the latch is pivoted on the bracket.

The shaft can comprise a protrusion and the bracket can comprise two notches formed on the inner wall of the bore, when the protrusion engages the notches respectively, the latch is positioned parallel or perpendicular to the bracket.

In another embodiment, the latch comprises a protrusion and the bracket comprises two holes. When the protrusion engages each of the holes respectively, the latch is positioned parallel or perpendicularly to the bracket.

When the latch is positioned parallel to the bracket, the height of the latch is less than that of the first depression.

The tray further comprises an accommodating portion disposed at the edge of the second depression. The first latching module is accommodated in the accommodating portion.

The tray further comprises at least one second latching module disposed at the edge of the first depression. When the tray is vertically placed, the first disc is positioned in the first depression by the second latching module. When the latch is positioned perpendicular to the bracket, the top of the latch is lower than the second latching module.

### BRIEF DESCRIPTION OF THE DRAWINGS

The invention can be more fully understood by reading the subsequent detailed description and examples with references made to the accompanying drawings, wherein:

FIG. 1 is schematic view of a conventional tray;

FIG. 2 is a partially enlarged cross section of portion A of FIG. 1;

FIG. 3 is a schematic view of an embodiment of a tray of the invention;

FIG. 4 is an enlarged view of portion B of FIG. 3;

FIGS. 5 and 6 are cross sections of the first latching module;

FIG. 7 is an exploded view of the first latching module;

FIGS. 8a and 8b depict two further embodiments of the first latching module respectively; and

FIG. 9 is a schematic view of an embodiment of the tray.

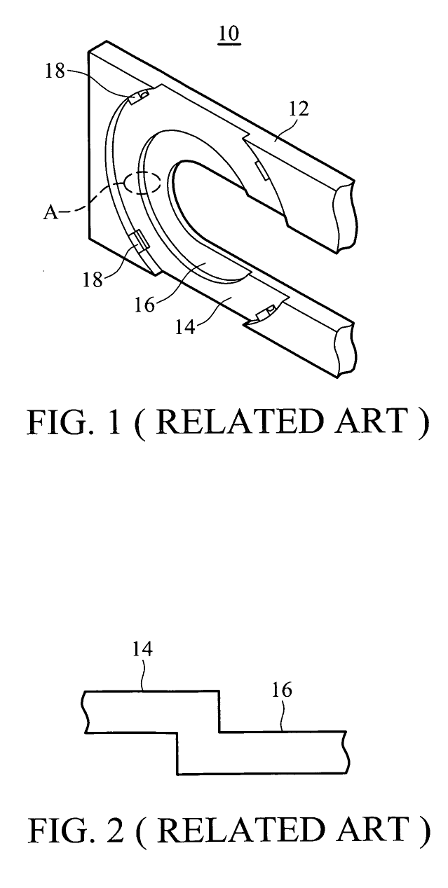

### DETAILED DESCRIPTION

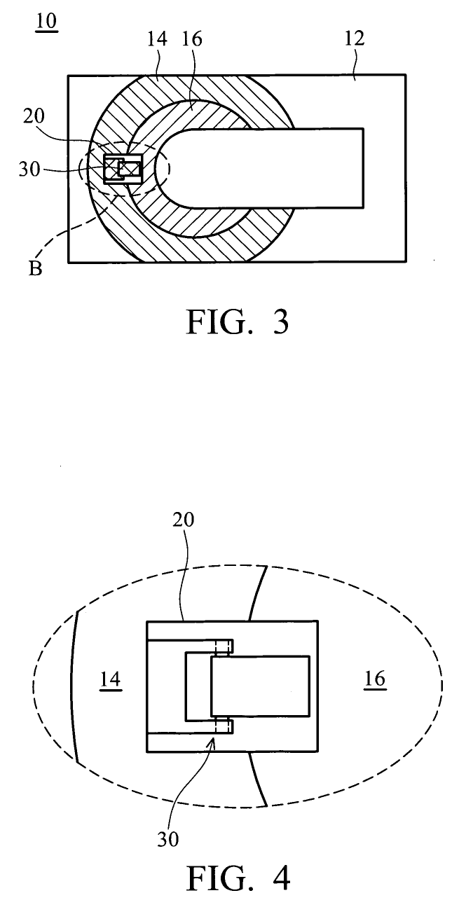

Referring to FIGS. 3 and 4, an accommodating portion 20 is disposed at the edge of the second depression 16. A latching module (first latching module) 30 is disposed in the accommodating portion 20. When a second disc of 8 cm in diameter is placed in the second depression 16 of the tray 10 vertically, the latching module 30 holds and positions the second disc.

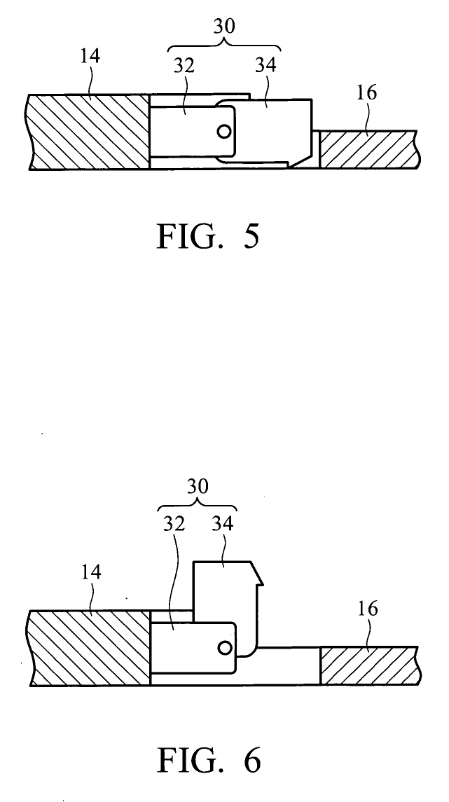

Referring to FIGS. 5 and 6, the latching module 30 comprises a bracket 32 fixed on the inner wall of the accommodating portion 20 and a latch 34 pivoted on the bracket 32. The latch 34 can be positioned parallel or perpendicular to the bracket 32. When the latch 34 is positioned parallel to the bracket 32, a first disc of 12 cm in diameter can be placed in the first depression 14 as shown in FIG. 5. At this time, the height of the bracket 32 and the latch 34 does not exceed that of the bottom of the first depression 14 preventing damage to the surface of the first disc. When the latch 34 is positioned perpendicular to the bracket 32, the second disc can be placed in the second depression 16, and the latch 34 holds and positions the second disc. The height of the latch 34 perpendicular to the bracket 32 is less than that of the latch 18 in the first depression 14, enabling smooth entry of the tray 10 into the optical drive. In another embodiment, the height of the latch 18 is not greater than that of the first depression 14. In such a condition, the height of the latch 34 cannot exceed that of the first depression 14.

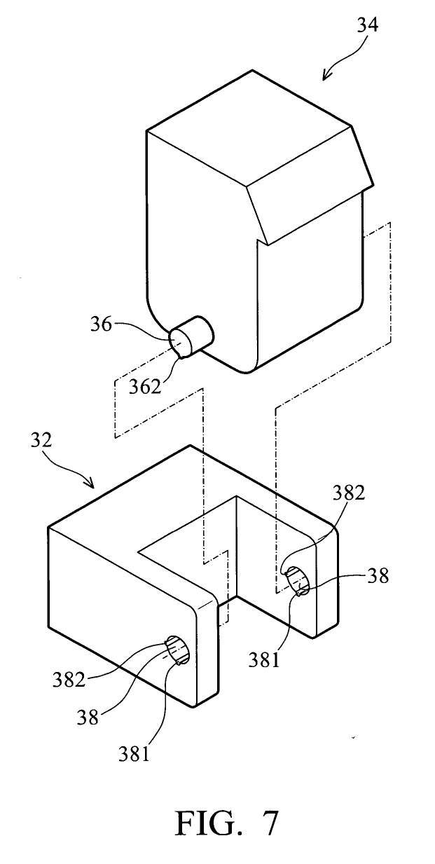

Referring to FIG. 7, the latch 34 comprises a shaft 36 having a protrusion 362. The bracket 32 comprises a bore 38. A first notch 381, and a second notch 382, are formed on the inner wall of the bore 38. The shaft 36 engages the bore 38, whereby the latch 34 is pivoted on the bracket 32. When the protrusion 362 engages the first notch 381, the latch 34 is positioned perpendicular to the bracket 32. When the protrusion 362 engages the second notch 382, the latch 34 is positioned parallel to the bracket 32. In this embodiment, the first notch 381 has an angle position separated from the second notch 382 by 90° so that the latch 34 can be positioned perpendicular and parallel to the bracket 32. The first notch 381 and the second notch 382 separated by an angle position less than 90° can also be employed as long as the second disc can be placed and positioned in the second depression 16. In such a condition, the latch 34 is at certain angle with respect to the bracket 32 rather than perpendicular thereto.

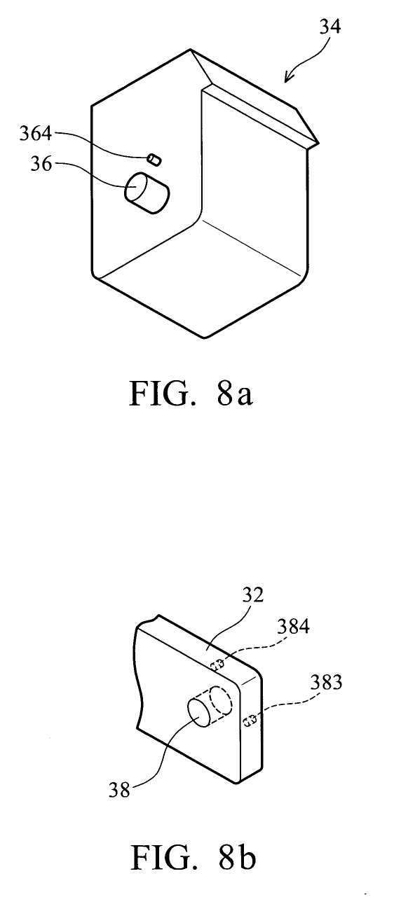

FIGS. 8a and 8b depict another embodiment of the latching module 30. A protrusion 364 is disposed on the lateral wall of the latch 34. Two holes 383 and 384 are formed on the bracket 32. When the protrusion 364 engages the holes 383 and 384 respectively, the latch 34 is positioned parallel and perpendicular to the bracket 32.

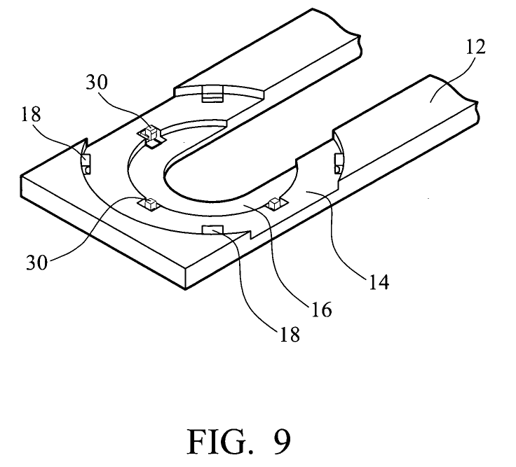

A plurality of latching modules 30 can be disposed on the second depression 16 to enhance positioning as shown in FIG. 9.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A tray for an optical drive, comprising:
a main body;
a first depression formed in the main body for a first disc;
a second depression formed in the first depression for a second disc smaller than the first disc; and
at least one first latching module disposed at the edge of the second depression, wherein when the tray is vertically disposed, the second disc is positioned in the second depression by the first latching module.

2. The tray as claimed in claim 1, wherein the first latching module comprises:
a bracket extending parallel to the first depression; and
a latch pivoted on the bracket and positioned parallel to the bracket or perpendicular to the bracket, wherein when the latch is parallel to the bracket, the first disc is received in the first depression, and when the latch is perpendicular to the bracket, the second disc is received in the second depression and positioned therein.

3. The tray as claimed in claim 2, wherein the bracket comprises a bore, and the latch comprises a shaft rotatably engaging the bore, whereby the latch is pivoted on the bracket.

4. The tray as claimed in claim 3, wherein the shaft comprises a protrusion and the bracket further comprises two notches formed on the inner wall of the bore, when the protrusion engages the notches respectively, the latch is positioned parallel or perpendicular to the bracket.

5. The tray as claimed in claim 3, wherein the latch comprises a protrusion and the bracket comprises two holes, when the protrusion engages the holes respectively, the latch is positioned parallel or perpendicular to the bracket.

6. The tray as claimed in claim 2, wherein when the latch is positioned parallel to the bracket, the height of the latch is less than that of the first depression.

7. The tray as claimed in claim 1 further comprising an accommodating portion disposed at the edge of the second depression, in which the first latching module is accommodated.

8. The tray as claimed in claim 1 further comprising at least one second latching module disposed at the edge of the first depression, wherein when the tray is vertically disposed, the first disc is positioned in the first depression by the second latching module.

9. The tray as claimed in claim 8, wherein when the latch is positioned perpendicular to the bracket, the top of the latch is lower than the second latching module.
